(19) United States
(12) Patent Application Publication
(10) Pub. No.: US 2006/0139651 A1
(43) Pub. Date: Jun. 29, 2006

(54) Method of producing thick nonlinear optical gratings

(75) Inventors: Arnaud Grisard, Paris (FR); Eric Lallier, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/536,696

(22) PCT Filed: Nov. 24, 2003
(86) PCT No.: PCT/EP03/50882

§ 371 Date: Nov. 8, 2005

(30) Foreign Application Priority Data
Nov. 29, 2002 (FR) 02 15075

(51) Int. Cl. G01J 3/45

(52) U.S. Cl. 356/452

(57) ABSTRACT

The field of the invention is that of thick nonlinear optical gratings used in particular in the fields of power lasers and high-rate telecommunications. The production of thick gratings poses major technological problems. The method proposed by the invention makes it possible either to obtain a high-quality nonlinear optical grating of substantial thickness, or to produce low-attenuation waveguides. This method applies most particularly to gratings based on semiconductor materials such as GaAs, which have great technical advantages. The core aspect of the invention is to prepare the surface of a thin first grating so that it is possible to deposit at least one layer of nonlinear material by epitaxy on this surface, the deposited layer maintaining the structural properties of the first grating, the combination of the initial deposition and of the successive layers constituting the final, thick grating.

### BACKGROUND OF THE INVENTION

1. Field of the Invention

The field of the invention is that of nonlinear optical gratings. In general, the interaction of light with an optically nonlinear material modifies its optical properties. Thus, one or more light waves are generated whose frequencies, phases or polarizations are different from those of the incident light. There are numerous applications. In particular, mention may be made of optical frequency doublers and optical frequency mixers, or optical amplifiers and optical parametric oscillators in the fields of power lasers and high-rate telecommunications.

2. Description of the Prior Art

The nonlinear optical effect depends on the susceptibility tensor of the material, which connects the induced polarization of the generated wave with the electric field of the incident wave. In general, this tensor of matrix form comprises 27 components called nonlinear coefficients and denoted by d.

Quadratic or 2nd-order nonlinear processes, which are the most frequently used, require phase matching between the incident wave, called the pump wave, and the wave or waves generated, called harmonic waves, during propagation in the nonlinear material. The dispersion of the optical indices between the pump wave and the harmonic waves makes it possible in practice to meet this condition only in a limited number of birefringent materials. Unfortunately, these materials do not necessarily possess the best nonlinear coefficients, wide wavelength ranges and sufficient beam focusing and operating temperature ranges.

The use of nonlinear optical gratings composed of structures based on nonlinear optical crystals makes it possible, under certain conditions, to partly circumvent these limitations. In particular, the technique called QPM (quasi-phase-matching) is used. This consists in locally modifying the nonlinear properties of a nonlinear crystal so that the phase mismatch between the waves that has built up over the course of the propagation is periodically compensated (J. A. Armstrong, N. Bloembergen, J. Ducuing and P. S. Pershan, “Interactions between light waves in a nonlinear dielectric”, Physical Review, Vol. 127, No. 6, pp. 1918-1939, 1962). In the case of ferroelectric materials, such as lithium niobate, it is known to reverse the sign of the dielectric polarization of domains a few microns in width, over the entire depth of the substrates, by applying an electric field along the Z crystallographic axis of this material. If d is the nonlinear coefficient involved, a beam propagating perpendicular to the Z crystallographic axis experiences a modulation in the susceptibility of the type +d/−d/+d/−d/+d/, etc., propitious to QPM. Depending on the desired spectral properties, it may be advantageous to use other combinations of nonlinear coefficients, with opposite or different values, with a constant or variable pitch, with a symmetrical or unsymmetrical duty cycle, with a single pitch or with successive sections of different pitches.

Certain semiconductors readily available thanks to the microelectronics industry, such as gallium arsenide (GaAs), have both high nonlinear coefficients and broad transparency ranges. However, these crystals belong to the crystallographic class of cubic symmetry, which makes them isotropic and therefore unsuitable for conventional birefringent phase matching. Moreover, they do not have ferroelectric properties that can be used for structuring a nonlinear optical grating, such as lithium niobate crystals.

However, it is possible to use Gas in QPM mode by manufacturing structures with a periodically inverted crystal orientation. For example, it is possible to produce monolithic stacks of GaAs plates assembled head to tail, and then to subject them to a baking operation under pressure (E. Lallier, M. Brevignon and J. Lehoux, “Effficient second-harmonic generation off a CO₂ laser with a quasi-phase-matched GaAs crystal”, Optics Letters, Vol. 23, No. 19, pp. 1511-1513, 1998). However, it is impossible in practice to handle a large number of thin plates, and this limits the interest in such stacks.

Epitaxial deposition methods allow GaAs structures to be manufactured with a periodically reversed crystal orientation with fewer constraints than the above technique as regards periods and lengths of the gratings.

For guided wave applications, epitaxial growth of the guiding layers is possible using a seed substrate comprising an array of thin GaAs bands of reversed orientation (J. B. Yoo, R. Dhat, C. Caneau and M. A. Koza, “Quasi-phase-matchad second-harmonic generation in AlGaAs waveguides with periodic domain inversion achieved by wafer-bonding”, Applied Physics Letters, Vol. 66, No. 25, pp. 3410-3412, 1995).

For applications involving high optical power levels, it is necessary to have bulk nonlinear optical gratings several hundred microns in thickness. Epitaxial deposition techniques of the OMCVD (organometallic chemical vapor deposition) and MBE (molecular beam epitaxy) type are not appropriate. The deposition technique using a seed substrate, selective in terms of crystal orientation, called HVPE (hydride vapor phase epitaxy) may nevertheless give thick nonlinear optical gratings starting from GaAs-based structures (L. Becouarn, B. Gerard, M. Brevignon, J. Lehoux, Y. Gourdel and E. Lallier, “Second-harmonic generation of CO₂ laser using thick quasi-phase matched GaAs layer grown by hydride vapor phase epitaxy” Electronics Letters, Vol. 34, No. 25, pp. 2409-2410, 1998 L. A. Eyres, P. J. Tourreau, T. J. Pinguet, C. B. Ebert, J. S. Harris, M. M. Fejer, L. Becouarn, B. Gerard and E. Lallier, “All-epitaxial fabrication of thick, orientation-patterned GaAs films for nonlinear optical frequency conversion”, Applied Physics Letters, Vol. 79, No. 7, pp. 904-907, 2001).

These techniques have major drawbacks. Although the HVPE growth rates on the two orientations present at the surface of the seed substrate are very similar, a residual difference remains and results in a surface with a pronounced relief, this point being identified as the cause of large propagation losses.

Growth defects also set a limit on the quality of the crystals obtained: the smaller the period of the nonlinear optical gratings, the more difficult it becomes to obtain these crystals faithfully with the seed substrate over a large thickness.

### SUMMARY OF THE INVENTION

The method proposed by the invention makes it possible either to obtain a nonlinear optical grating of high quality over substantial thicknesses or to produce waveguides that include a nonlinear optical grating without substantial attenuation. This method applies most particularly to gratings based on semiconductor materials such as GaAs, which have major technical advantages both from the standpoint of their physical properties and their technology employed.

More precisely, the subject of the invention is a method of producing a thick nonlinear optical grating from an initial thick nonlinear optical grating, the thickness of the nonlinear optical grating being greater than the thickness of the initial nonlinear optical grating, said initial grating comprising at least one plurality of mutually parallel plane layers, said layers having at least two nonlinear coefficients having algebraically different values, said initial grating having a first face and a second face that are approximately parallel to each other and approximately perpendicular to the mean plane of the layers, and said second face being free, the method comprising the following production steps:
a first step of determining the thickness of that upper part of the initial grating which lies beneath the second face, which upper part has structural imperfections;
said a second step of polishing the second face of said initial grating, making it possible to remove the upper part having said imperfections and to obtain a polished and plane third face, said face approximately perpendicular to the mean plane of the layers;
a third step of cleaning and checking said third face; and
at least a fourth step of epitaxially depositing at least one layer of material deposited on said third face, the epitaxial growth reproducing, in said deposited layer, a structure similar to that of the initial grating, the combination of the initial grating and said deposited layer constituting the nonlinear optical grating.

### BRIEF DESCRIPTION OF THE DRAWINGS

The invention will be more clearly understood and other advantages will become apparent on reading the following description given by way of nonlimiting example and thanks to the appended figures in which:

FIGS. 1 to 4 show the various steps of the production method according to the invention. They comprise a general sectional view of the grating and an encircled enlarged partial view showing the structure of the grating;

FIGS. 5a and 5b show the various steps of the production of the first optical grating, in the case in which it is made from a monolithic assembly of crystalline plates; and

FIGS. 6a to 6c show the various steps of a method of preparing the grating that makes it easier to carry out the operation of polishing the initial optical grating.

### MORE DETAILED DESCRIPTION

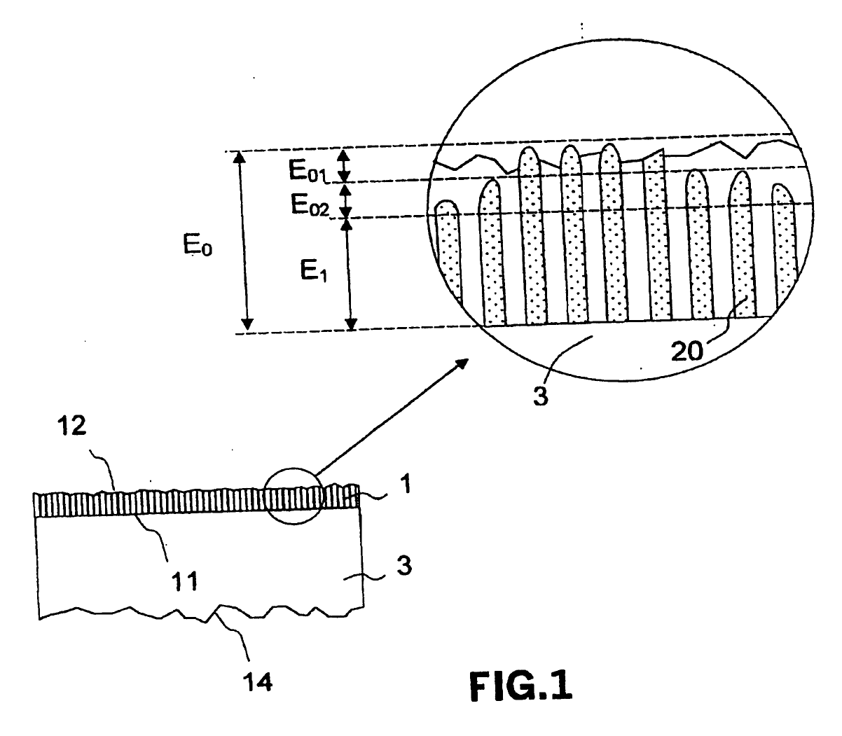

FIG. 1 is a view in section and an enlarged view of the initial nonlinear optical grating 1. This grating 1 has a plurality of layers 20 whose linear coefficients vary from one layer to the next layer. This grating has a first face 11 and a second face 12 that are approximately parallel. There are various methods of producing said initial grating.

In a first embodiment, as shown in FIG. 1, the nonlinear material is deposited on a seed substrate 3. This comprises a crystalline material having a first crystal orientation, the upper face 11 of the seed substrate having a thin structure, said structure being formed from what is called the precursor grating of parallel bands of the same crystalline material but of reverse crystal orientation to that of the crystalline material of the seed substrate 3. The deposition is carried out, for example, by the HVPE epitaxial growth method on the upper face 11 of the seed substrate. In this case, the deposition, which is selective in terms of crystal orientation, is carried out over a total thickness E₀. This thickness includes, on the one hand, imperfections on the surface 12 over a first thickness E₀₁ and, on the other hand, structural imperfections over a second thickness E₀₂ that are due, for example, to the variations in growth rate of the various layers during deposition or due to initial defects in the seed substrate. The useful thickness E₁ is therefore given by:
E₁=E₀−E₀₁−E₀₂.

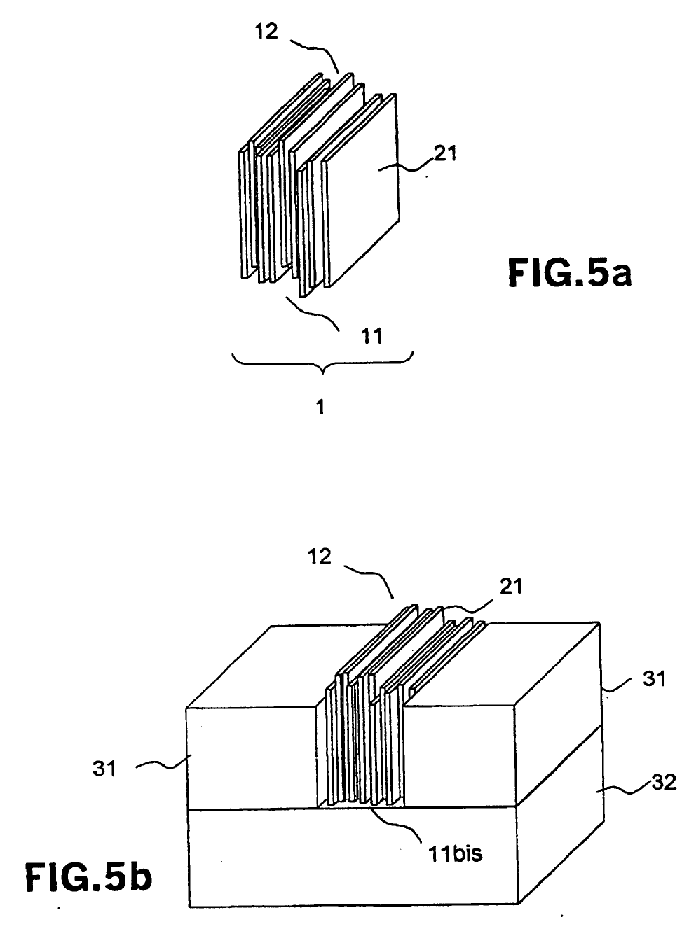

In a second embodiment, the method of producing the initial optical grating comprises the following steps:
a first substep of producing a stack of crystalline plates 21 having plane parallel faces, of the same material, of small thickness and of periodically alternating crystal orientation; and
a second substep of assembling said plates so as to obtain a single monolithic assembly constituting said initial optical grating 1, said grating having a first face 11 and a second face 12 that are approximately perpendicular to the mean plane of the crystalline plates as shown in FIG. 5a.

Here again, it is impossible to obtain a perfect stack over its entire thickness, and consequently the faces of the stack also have surface and structural imperfections.

The first step of the production method consists in determining the useful thickness E₁. Since the thicknesses of the various layers are of the order of a few microns to a few tens of microns, the means of determining the thickness, including the imperfections, are optical display devices. Observation via the edge of the initial grating allows the thicknesses E₀, E₀₁ and E₀₂ to be determined. Optionally, a cut may be made into the substrate so that the grating is flush with the substrate after cutting, which thus improves the observation. A chemical development operation may also be carried out, so as to improve the contrast.

Before the second step of the production method is carried out, preliminary preparation steps may be performed so as to make said step easier.

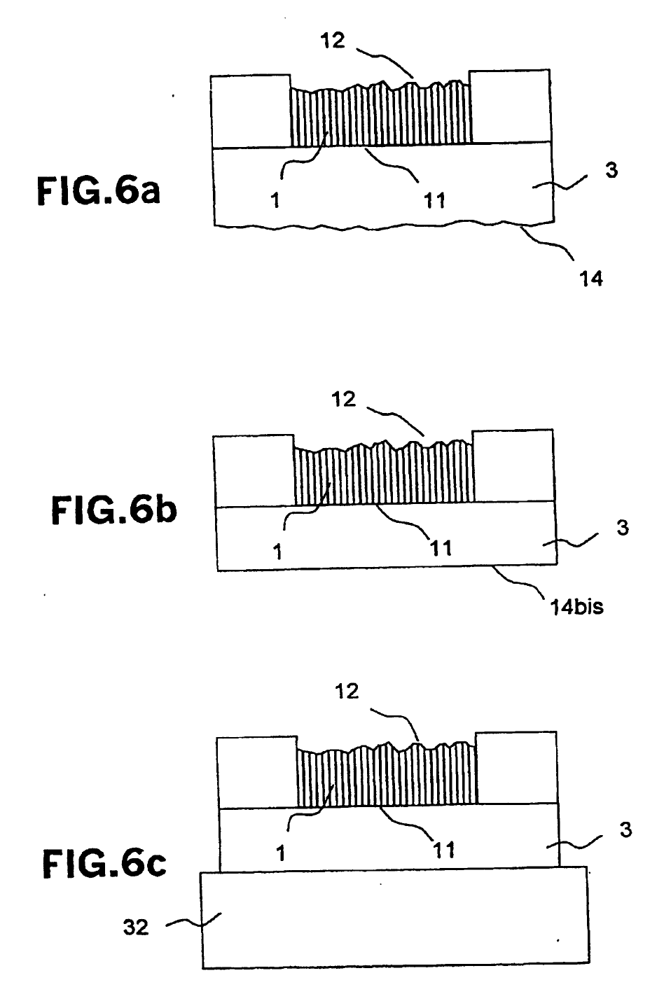

These preliminary steps are shown in FIGS. 6a to 6c in the case in which the initial grating is produced on a seed substrate. They comprise:
a first preliminary step of polishing the lower face 14 of the substrate in order to obtain the plane polished face 14a (FIG. 6a and FIG. 6b); and
a second preliminary step of bonding at least said lower face 14a to at least one plane support 32 (FIG. 6c), the fitting of the support making it easier to handle the initial optical grating for the subsequent polishing operations.

The preliminary steps in the case in which the initial grating is a monolithic stack of crystalline plates are the following:
a first preliminary step of polishing the first face 11 of the monolithic stack in order to obtain the plane face 11a; and
a second preliminary step of bonding at least said first face 11a to at least one plane support 32 as indicated in FIG. 5b, the fitting of the support making it easier to handle the monolithic assembly for the subsequent operations of polishing the second face. Optionally, lateral reinforcements 31 may be placed on at least one side of the monolithic stack 2, said reinforcements being bonded to the support 32.

The second step of the production method consists, firstly, in polishing the face 12 by mechanical abrasion so as to remove the surface perturbations present in the thicknesses E₀₁ and E₀₂ and secondly in then supplementing this first polishing operation with a second, chemical-mechanical polishing operation and in obtaining sufficient surface quality to carry out epitaxial deposition. The polished plane face 13 approximately perpendicular to the mean plane of the layers of the grating 1 is therefore obtained. This second operation may prove to be superfluous under certain epitaxial deposition conditions using the HVPE method.

When the first grating has been produced on a large substrate, typically with a diameter greater than 50 millimeters (i.e. equivalent to a standard wafer diameter of 2 inches), it is possible to polish the face 12 of the grating and the lower face 14 of the substrate simultaneously in a twin-platen polisher. These polishers are used in particular in the microelectronics industry to polish semiconductor wafers. However, in this case it is more difficult to control the thickness and the quality of the grating obtained. Therefore the procedure is to carry out successive steps until a polished grating no longer containing structural perturbations is obtained.

In order for this polishing operation to be performed successfully, the grating must not be too fragile. When the initial grating has been produced on a substrate, a minimum thickness of 50 microns for the grating alone and 300 microns for the substrate for is desirable; when the initial grating does not include a substrate, a minimum thickness of 350 microns is desirable.

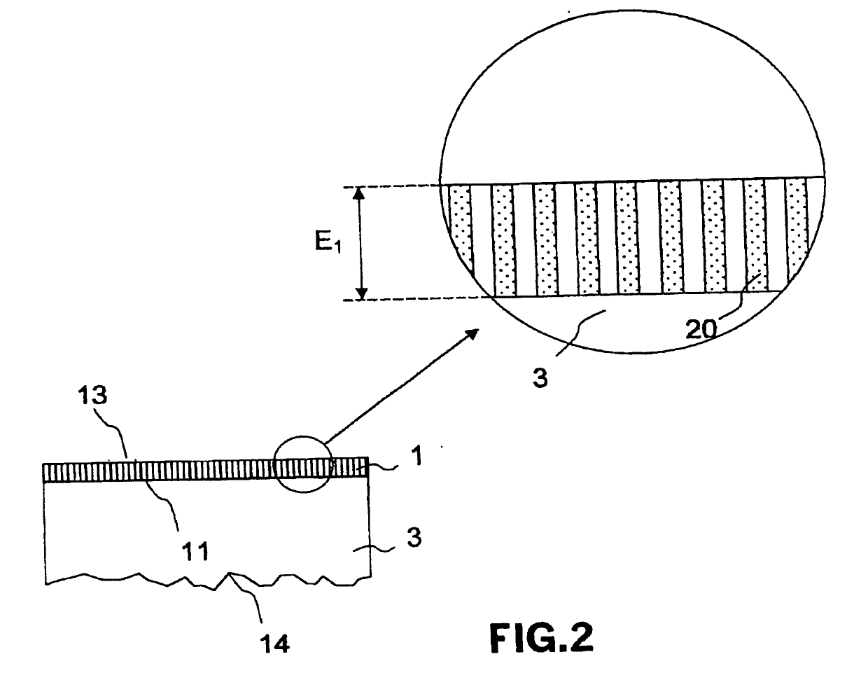

What is obtained at the end is the grating shown in FIG. 2. The second face 12 has become the third, plane face 13. The thickness of the grating is now E₁.

In a third step of the method, the surface 13 is cleaned and checked, for example by optical means, so as to confirm that the grating is ready to be used for epitaxial deposition under conditions that will preserve the structure of the grating.

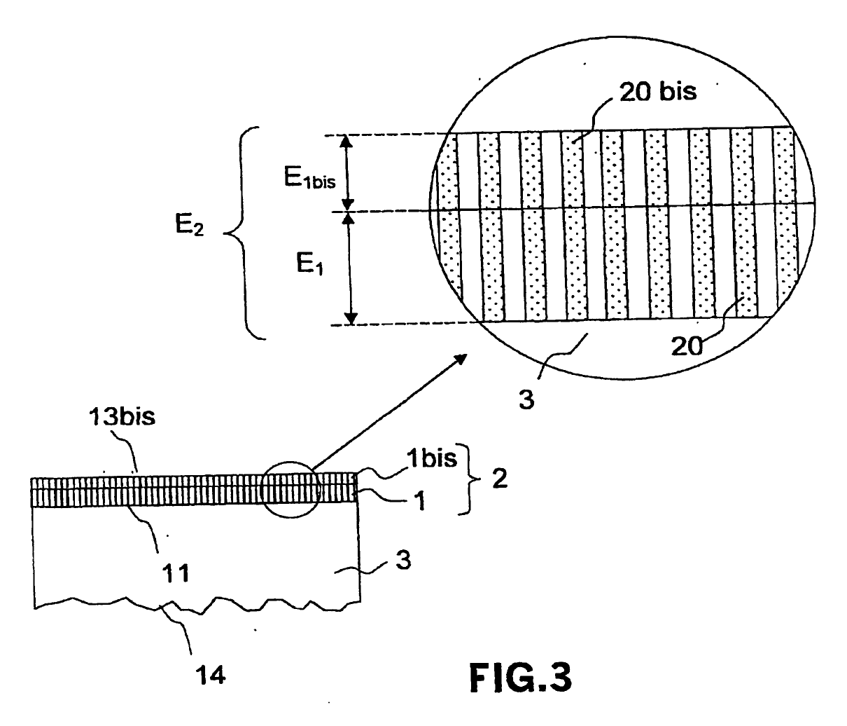

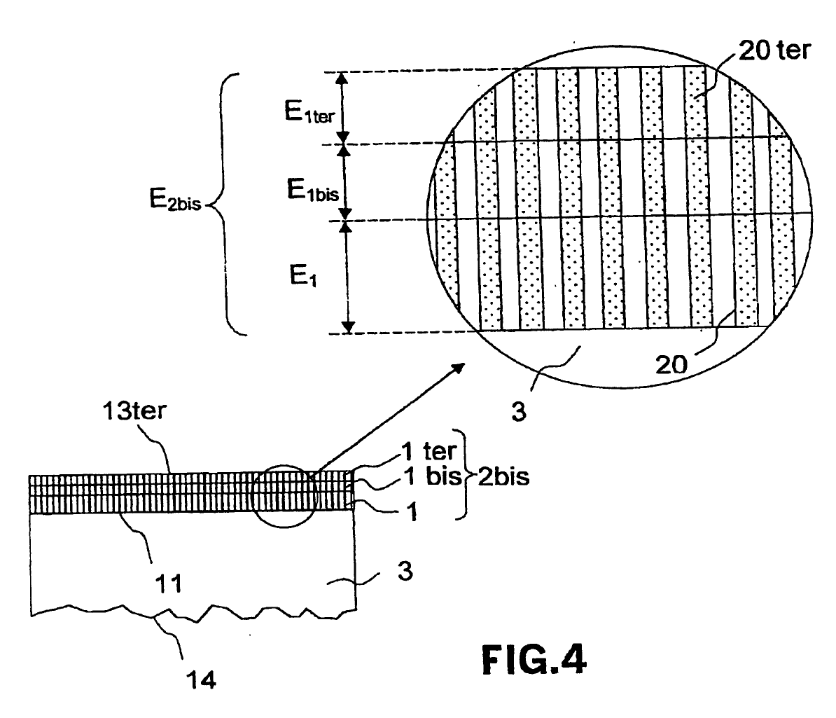

Finally, in a fourth step of the method, at least a first layer 1a of material is deposited on said third face 13 under conditions that preserve the structure of the first grating, the combination of the first grating 1 and the said layer 1a constituting the second nonlinear optical grating 2, as indicated in FIG. 3. Since the layer 1a has a thickness E₁ₐ, the final thickness of the grating will now be E₂, where:
E₂=E₁ₐ+E₁.
Of course, it is possible to repeat the fourth step at least once, as indicated in FIG. 4. In this figure, a second layer 1b of thickness E_{1b} is deposited on the layer 1a. In the end, the grating therefore has a total thickness E₂ₐ given by:
E₂ₐ=E₂+E_{1b}=E_{1b}+E₁ₐ+E₁.

This technique may be used:
either to increase the final thickness of the grating, each layer then being composed of the same material;
or to produce particular functions of the waveguide type, the materials of two successive layers then having different optical properties such as, in particular, their optical index.

The layers are deposited by epitaxy. Among possible methods, mention may be made of:
the OMCVD epitaxial growth method and the MBE epitaxial growth method for producing layers not exceeding a few microns in thickness; and
the HVPE epitaxial growth method for producing thicker layers.

If the starting substrate includes zones with no nonlinear optical grating, the quality with which its surface is prepared may also make it possible to fabricate by epitaxy, using the OMCVD or MBE methods, structures that are co-integrated with nonlinear optical grating waveguides, such as for example laser diodes, optical modulators, Bragg grating sections, etc.

There are various possible materials allowing nonlinear optical gratings to be produced. For example, it is possible to use a crystal belonging to the 43 m crystallographic class.

The susceptibility tensor for this crystallographic class is given below:

$$( \begin{matrix}0 & 0 & 0 & d & 0 & 0 \\ 0 & 0 & 0 & 0 & d & 0 \\ 0 & 0 & 0 & 0 & 0 & d\end{matrix} )$$

Such a crystal may be a gallium arsenide (GaAs) or indium phosphide (InP) or cadmium telluride (CdTe) or zinc selenide (ZnSe) or zinc telluride (ZnTe) or gallium phosphide (GaP) or indium arsenide (InAs) or indium antimonide (InSb) crystal.

The material may also be tellurium (Te) or selenium (Se) or gallium nitride (GaN)

It is also possible to use gallium aluminum arsenide (GaAlAs) for producing layers of different indices for producing waveguides.

1. A method of producing a thick nonlinear optical grating (2) with a thickness of several hundred microns from an initial thick nonlinear optical grating (1), the thickness (E₂) of the nonlinear optical grating (2) being greater than the thickness (E₀) of the initial nonlinear optical grating (1), said initial grating comprising at least one plurality of mutually parallel plane layers (20), said layers having at least two nonlinear coefficients having algebraically different values, said initial grating having a first face (11) and a second face (12) that are approximately parallel to each other and approximately perpendicular to the mean plane of the layers, and said second face (12) being free, characterized in that it comprises the following production steps:
a first step of determining the thickness (E₀₁, E₀₂) of that upper part of the initial grating (1) which lies beneath the second face (12), which upper part has structural imperfections;
a second step of polishing the second face (12) of said initial grating (1), making it possible to remove the upper part having said imperfections and to obtain a polished and plane third face (13), said face approximately perpendicular to the mean plane of the layers (20);
a third step of cleaning and checking said third face (13); and
at least a fourth step of epitaxially depositing at least one layer (1a, 1b) of material deposited on said third face (13), the epitaxial growth reproducing, in said deposited layer, a structure similar to that of the initial grating, the combination of the initial grating (1) and said deposited layer (1a, 1b) constituting the nonlinear optical grating (2).

2. The method of producing an optical grating (2) as claimed in claim 1, characterized in that the means of determining the thickness having imperfections are optical display devices.

3. The method of producing a nonlinear optical grating (2) as claimed in either of the preceding claims, characterized in that, after the second production step, the thickness (E₁) of the initial optical grating is at least 50 microns.

4. The method of producing a nonlinear optical grating (2) as claimed in claim 1, characterized in that the initial nonlinear optical grating (1) is supported by a seed substrate (3) having a lower face (14) and a plane upper face (11), the upper face (11) of the seed substrate coinciding with the first face (11) of said initial nonlinear optical grating (1).

5. The method of producing a nonlinear optical grating (2) as claimed in claim 4, characterized in that the seed substrate (3) comprises a crystalline material having a first crystal orientation, the upper face (11) of the seed substrate having a thin structure, said structure being formed from a precursor grating of parallel bands of the same crystalline material but of the opposite orientation to that of the seed substrate (3).

6. The method of producing a nonlinear optical grating (2) as claimed in claim 5, characterized in that the thickness of the seed substrate (3) is at least 300 microns.

7. The method of producing an optical grating (2) as claimed in claim 4, characterized in that the second production step includes the following preliminary steps:
a first preliminary step of polishing the lower face (14) of the substrate; and
a second preliminary step of bonding at least said lower face (14) to at least one plane support (32), the fitting of the support making it easier to handle the initial optical grating (1) for the subsequent polishing operations.

8. The method of producing a nonlinear optical grating (2) as claimed in claim 4, characterized in that the initial nonlinear optical grating (1) is obtained by the epitaxial growth method called HVPE (hydride vapor phase epitaxy) on the upper face of the seed substrate (3).

9. The method of producing an optical grating (2) as claimed in claim 1, characterized in that the method of producing the initial nonlinear optical grating (1) includes the following substeps:
a first substep of producing a stack of crystalline plates (21) having plane parallel faces, of the same material, of small thickness and of periodically alternating crystal orientation; and
a second substep of assembling said crystalline plates so as to obtain a single monolithic assembly (1) constituting the initial optical grating, said initial grating having a first face (11) and a second face (12) that are approximately perpendicular to the mean plane of the crystalline plates.

10. The method of producing an optical grating as claimed in claim 9, characterized in that the second step in the production of the initial grating (2) is preceded by the following preliminary steps:
a first preliminary step of polishing the first face (11) of the monolithic stack; and
a second preliminary step of bonding at least said first face (11) to at least one plane support (32), the fitting of the support making it easier to handle the monolithic assembly for the subsequent operations of polishing the second face (12).

11. The method of producing an optical grating (2) as claimed in one of the preceding claims, characterized in that, during the fourth production step, at least two layers (1a, 1b) of materials of different optical index are deposited so as to form an optical waveguide.

12. The method of producing a nonlinear optical grating (2) as claimed in one of the preceding claims, characterized in that, during the fourth production step, at least one of the layers (1a, 1b) is obtained by the epitaxial growth method called OMCVD (organometallic chemical vapor deposition) or by MBE (molecular beam epitaxy).
